(19) United States
(12) Patent Application Publication
(10) Pub. No.: US 2005/0278112 A1
(43) Pub. Date: Dec. 15, 2005

(54) Process for predicting the course of a lane of a vehicle

(76) Inventors: Axel Gern, Leutenbach (DE); Uwe Franke, Uhingen (DE); Carsten Knoeppel, Stuttgart (DE)

Correspondence Address: PENDORF & CUTLIFF, 5111 MEMORIAL HIGHWAY, TAMPA, FL, 33634-7356, US

(21) Appl. No.: 11/152,640

(22) Filed: Jun. 14, 2005

(30) Foreign Application Priority Data
Jun. 14, 2004 (DE) 10 2004 028 404.0

(51) Int. Cl. G01C 21/26

(52) U.S. Cl. 701/200

(57) ABSTRACT

The present invention relates to a method for estimating the course of a lane of a motor vehicle, where the course of the lane is detected by detecting the trajectory of a vehicle traveling in front in the lane, where the detected course of the trajectory subjected to filtering in order to obtain the actual course of the trajectory, where the course of the trajectory is evaluated by means of at least two different filters, where movements of the vehicle in the lateral direction in the lane are filtered on the basis of the output of a filter, and where movements of the vehicle which correspond to a lane change are detected on the basis of the output of a further filter.

### BACKGROUND OF THE INVENTION

1. Field of the Invention

The invention relates to a method for estimating the course of a lane of a motor vehicle according to the preamble of claim 1.

### RELATED ART OF THE INVENTION

DE 197 49 086 C1 discloses combining the sensor data of an optical close-range lane detection means and an object detection sensor system for measured objects lying further away, by means of a Kalman filter as the estimating device, to determine therefrom, by means of a vehicle model, whether or not objects which are located in front are located in the lane.

Furthermore, it is known from the paper by Niehsen and Müller presented to the Fahrerassistenz-Workshop (Driver assistance workshop) 2003 with the title “IMM-Tracking-Filter für Fahrerassistenzsysteme (IMM Tracking Filters for driver assistance systems)”, to use multi-filter systems for estimating the lateral track error of a vehicle. As a result, lateral accelerations of vehicles traveling in front of different orders of magnitude can be detected.

U.S. Pat. No. 6,643,588 B1 discloses detecting the curvature of a bend and the lane used by vehicles traveling in front by evaluating, with respect to a specific curvature of the road, whether the angle between the straight-ahead travel of the vehicle and one or more target vehicles has changed. An example with three target vehicles is described here. If it is detected that the angle with respect to all the target vehicles has changed in the same way it is determined that the driver's own vehicle has changed its lane. If it is detected that a change in angle has occurred for only one of the target vehicles, it is determined therefrom that the respective target vehicle has changed its lane. Furthermore, the geometric conditions according to which a different course of the change of the angle between the vehicles results from the driver's own vehicle with respect to a target vehicle when the driver's own vehicle changes lane than when the target vehicle changes lane are described. This is due to the fact that in the first case the orientation of the driver's own vehicle with respect to the direction of the lane changes during the lane-changing process, specifically in a certain direction when the lane change is initiated and in the opposite direction at the end of the lane-changing process. The occurrence of these geometric conditions has been explained without this characteristic of the detection and differentiation of the lane change of the driver's own vehicle from a lane change of the target vehicle having been specifically described. The method which is described in the aforesaid citation is based on the fact that the bend has a constant curvature and the radius of the bend both of the section of road on which the driver's own vehicle is traveling and the section of road on which the target vehicle is traveling does not change between two measuring points.

DE 101 59 658 A1 discloses detecting a lane change of a vehicle traveling in front when a travel direction indicating signal from the vehicle traveling in front is detected.

U.S. Pat. No. 6,675,094 B2 discloses determining the course of a lane for a vehicle by evaluating the paths of vehicles traveling in front. In order to determine the current position of the vehicle, the course of the path (radius of curvature) and in order to predict the further course it is known to use a Kalman filter. Sensor signals are evaluated for the course of the path of the driver's own vehicle. The yaw rate and the speed of the vehicle are measured. The current radius of a bend is determined from these variables. The Kalman filter is used to eliminate the noise signal of the sensors and peaks in the sensor signal which have nothing to do with the course of the road in the sense of the application of automatic driving systems. Such peaks may occur, for example, when there are potholes, ridges in the ground or the like. Moreover, in U.S. Pat. No. 6,675,094 B2 the intention is to evaluate the course of a plurality of vehicles traveling in front in order, on the one hand, to be able to carry out a statistical evaluation and, on the other hand, to be able to infer a lane change through a change in the position of the driver's own vehicle in the same direction as a plurality of the other vehicles.

### SUMMARY OF THE INVENTION

In view of the above, the present invention is based on the object of improving the estimation of the course of a lane.

This object is achieved according to the present invention as claimed in claim 1 in that the course of the trajectory of at least one vehicle traveling in front is evaluated by means of at least two different filters, where movements of the vehicle in the lateral direction in the lane are filtered on the basis of the output of a filter, and where movements of the vehicle which correspond to a lane change are detected on the basis of the output of a further filter.

By means of the output of one of the filters a signal is thus acquired which is then used if a lane change does not occur. This signal which has been filtered with a relatively long time constant eliminates lateral movements of the vehicle in the lane by filtering with a corresponding time constant.

The output of the further filter is used to detect whether a lane change occurs. For this purpose, this filter has a relatively short time constant so that the dynamics during a lane change can also be sensed. The other filter is also advantageously used to differentiate whether the dynamics are such that ultimately the vehicle remains in the lane or are dynamic changes which allow a change in the lane to be inferred.

This may occur, for example, in that in addition to the absolute value of the lateral speed an evaluation is also carried out to determine whether a uniquely defined direction which makes it possible to infer a lane change can be detected. As a result, dynamics which are due to a lane change can be differentiated from dynamics which are due to the vehicle moving to and fro in the lane.

It is also advantageously apparent that by including the method for evaluating the lateral track error, by means of a multi-filter system, into the method for estimating the course of the lane it is possible to detect driving maneuvers such as lane changes quickly and reliably. In comparison with purely using multi-filter systems it becomes apparent that there is an advantageous association with a lane detection so that the evaluation of the lateral track error does not stand alone. Furthermore it proves advantageous that when the multi-filter systems are included in the method for estimating the course of the lane, it is possible to avoid inaccuracies in the described multi-filter systems, said inaccuracies being due to the fact that during the pure evaluation of the lateral track error by means of the multi-filter systems the vehicle's own movement has to be known comparatively accurately. Particularly when there are relatively large distances from other vehicles, corresponding inaccuracies have significant effect here.

With the configuration of the method as claimed in claim 2, when a lane change is detected on the basis of the output of the further filter of this lane change is taken into account during the detection of the lane from the trajectory of this vehicle.

In the case of multi-lane carriageways the trajectory of a vehicle can also continue to be obtained for the estimation of the course of the driver's own vehicle when a lane change is detected. This proves advantageous whenever there is only a limited number of objects available for the corresponding estimation. This is the case, for example, when there is a low traffic density or when there are unfavorable visibility conditions and weather conditions in which only some of the objects present can be detected.

With the configuration of the method as claimed in claim 3, the position data of a plurality of successive measurement processes are stored, where when a lane change is detected position data which is stored for the past is newly evaluated with changed filter parameters in order to determine the course of the lane.

It proves advantageous here that during the ensured evaluation that a lane change is taking place, the measurement data which has already been acquired can be re-evaluated once more so that the measurement data which has been influenced by the lane change is correspondingly taken into account in the estimation of the course of the lane.

With the embodiment of the method as claimed in claim 4, probabilities of a lane change or of the vehicle staying in the lane are determined by means of statistical methods on the basis of previously measured data.

It proves advantageous here that it is not necessary for a lane change to be inferred from the outputs of the filters in an exact way and as a function of specific limiting values being exceeded. Instead it is possible to form a corresponding pattern on the basis of the typical profile of the lateral tracking deviation and the change in the lateral tracking deviation in the event of a lane change in the past. If such a pattern is detected again, it is possible to infer with a certain degree of probability that a lane change occurs. Preferably, early detection of a lane change is thus possible with an improved level of reliability.

In a beneficial way map information is additionally evaluated in order to assess the course of the trajectory by means of different filters. This information may be map information which is made available by navigation systems in modern vehicles. It is possible, so to speak, for the map information to be information which can be called by means of a communications link which is external to the vehicle. In this context the map information supplies geometry data about the course of the lane and the relative position of the vehicle with respect to the lane. Furthermore, objects which are associated with the vehicle infrastructure, for example road signs, traffic lights, lane boundaries etc. may also be stored in the map information and be used within the scope of the assessment of the course of the trajectory of a vehicle traveling in front.

It is also possible that a plurality of objects which are located in the surroundings of the vehicle are detected and evaluated in order to assess the course of the trajectory. This includes both other road users, and, for example, lane markings, lane boundaries, and road signs. If no map information is available or no information on the abovementioned objects is stored in it, it may be of great advantage also to use a sensor system which permits three-dimensional sensing of the surroundings in order to determine the distance from these objects.

The accuracy of the estimation can be increased by merging information from a plurality of sensors in order to assess the course of the trajectory. A number of different sensors, for example cameras, radar systems, lidar systems and laser scanners, are already known for sensing the surroundings in vehicles. The surroundings information which is acquired in this way can particularly advantageously be merged and used together or individually with the filter systems for the assessment of the course of the trajectory.

Overall, the use of the present invention improves the timing behavior of what are referred to as ACC (Adaptive Cruise Control) systems because more reliable detection of the behavior of other objects is made possible.

1. A method for predicting the course of a lane of a motor vehicle, comprising:
detecting the course of the lane by detecting the trajectory of at least one vehicle traveling in front in the lane,
subjecting the detected course of the trajectory to filtering in order to obtain the actual course of the trajectory,
wherein the course of the trajectory is evaluated by means of at least first and second filters,
wherein movements of the at least one vehicle in the lateral direction in the lane are filtered on the basis of the output of the first filter, and
wherein movements of the at least one vehicle which correspond to a lane change are detected on the basis of the output of the second filter.

2. The method as claimed in claim 1, wherein when a lane change is detected on the basis of the output of the second filter this lane change is taken into account in the detection of the lane from the trajectory of this vehicle.

3. The method as claimed in claim 1, wherein the position data of a plurality of successive measurement processes are stored, where when a lane change is detected position data which is stored for the past is newly evaluated with changed filter parameters in order to determine the course of the lane.

4. The method as claimed in claim 1, wherein probabilities of a lane change or of the vehicle staying in the lane are determined by means of statistical methods on the basis of previously measured data.

5. The method as claimed in claim 1, wherein map information is additionally evaluated in order to assess the course of the trajectory.

6. The method as claimed in claim 1, wherein a plurality of objects which are located in the surroundings of the vehicle are additionally detected and evaluated in order to assess the course of the trajectory.

7. The method as claimed in claim 1, wherein information from a plurality of sensors is merged in order to assess the course of the trajectory.
